(19) United States
(12) Patent Application Publication
(10) Pub. No.: US 2026/0284801 A1
(43) Pub. Date: Sep. 24, 2026

(54) APPARATUS AND METHOD FOR INSPECTING ADDITIVELY MANUFACTURED STRUCTURE

(71) Applicant: Electronics and Telecommunications Research Institute, Daejeon (KR)

(72) Inventors: Keo Sik KIM, Daejeon (KR); Kyeeun KIM, Daejeon (KR); Young Soon HEO, Daejeon (KR)

(73) Assignee: Electronics and Telecommunications Research Institute, Daejeon (KR)

(21) Appl. No.: 19/459,468

(22) Filed: Jan. 26, 2026

(30) Foreign Application Priority Data
Mar. 21, 2025 (KR) 10-2025-0036374

(51) Int. Cl. B23K 31/12; B23K 9/04; B33Y 50/00

(52) U.S. Cl. CPC B23K 31/125; B23K 9/04; B33Y 50/00

(57) ABSTRACT

Provided are an apparatus and method for inspecting an additively manufactured (AM) structure. The apparatus includes a vision camera and a processor functionally connected to the vision camera. The processor generates a layer image for identifying a deposition state of an AM structure through the vision camera, measures defect features and layer features of the AM structure from the layer image, and estimates a mechanical property of the AM structure on the basis of the defect features and the layer features.

### CROSS-REFERENCE TO RELATED APPLICATION

This application claims priority to and the benefit of Korean Patent Application No. 10-2025-0036374, filed on Mar. 21, 2025, the disclosure of which is incorporated herein by reference in its entirety.

### BACKGROUND

### 1. Field of the Invention

Various exemplary embodiments disclosed in the present document relate to an additively manufactured (AM) structure inspection technology.

### 2. Discussion of Related Art

Additive manufacturing is a method of constructing a structure layer by layer, commonly known as three-dimensional (3D) printing. Additive manufacturing processes are utilized to produce structures suited to user objectives due to their superior quality and ease of fabricating complex shapes. Also, since a variety of materials may be used in additive manufacturing processes, additive manufacturing is applied to various fields such as aviation, space, automobile, medicine, biotechnology, etc., and is growing rapidly.

Representative additive manufacturing processes include direct energy deposition (DED) and powder bed fusion (PBF).

DED is a method of melting additive manufacturing powder or wire at a high temperature using an energy source (laser, electron beam, or plasma arc) to build up a desired shape layer by layer. For example, in a wire arc additive manufacturing (WAAM) process, a metal material fed in wire form is melted with arc and deposited layer by layer to generate a structure.

PBF is a method of spreading a thin layer of metal powder and selectively melting a desired area using a laser or electron beam to stack a layer.

DED has advantages over PBF for manufacturing and repairing large structures at lower production costs. On the other hand, DED exhibits lower process precision than PBF and requires high-level additive robot control and thermal control technologies to enhance interlayer bonding strength.

### SUMMARY OF THE INVENTION

Additively manufactured (AM) structures produced through additive manufacturing processes (hereinafter “AM results) are tested for mechanical properties in various ways.

FIGS. 1 to 4 are views illustrating methods of inspecting an additive manufacturing structure. FIG. 1 shows a tensile strength measurement method involving specimen collection, and FIG. 2 shows a cross-section/surface inspection method employing scanning electron microscopy (SEM). FIG. 3 shows a vision inspection method, and FIG. 4 shows an internal defect inspection method employing adaptive ultrasound or x-ray.

Referring to FIG. 1, mechanical properties of an AM structure are inspected by collecting a specimen from the AM structure completed in accordance with International Organization for Standardization (ISO) 6892-1 (metallic materials-tensile testing) standards and directly measuring tensile strength using an extensometer or a strain gauge.

Alternatively, referring to FIG. 2, AM structure inspection may be performed using SEM for qualitative/quantitative analysis through cross-sectional observation of the AM structure, surface observation thereof, microdefect observation, and contrast differentiation.

As shown in FIG. 3, mechanical properties of an AM structure may be non-destructively inspected by detecting defects and determining the AM structure to be defective through images captured by a vision camera. Alternatively, mechanical properties of an AM structure may be determined through internal defect inspection using adaptive ultrasound or x-ray as illustrated in FIG. 4.

Various embodiments disclosed in the present document provide an AM structure inspection apparatus and method for estimating mechanical strength of an AM structure on the basis of defects and features of a layer image during additive manufacturing.

According to an embodiment disclosed in the present document, there is provided an apparatus for inspecting an AM structure of an additive manufacturing process, the apparatus including a vision camera and a processor functionally connected to the vision camera. The processor generates a layer image for identifying a deposition state of an AM structure through the vision camera, measures defect features and layer features of the AM structure from the layer image, and estimates a mechanical property of the AM structure on the basis of the defect features and the layer features.

According to an embodiment disclosed in the present document, there is provided an apparatus for inspecting an AM structure, the apparatus including a first measurement module configured to measure defect features detected from a layer image of an AM structure, which is an image for identifying a deposition state, a second measurement module configured to measure layer features related to layer uniformity of the AM structure from the layer image, and an estimator configured to estimate a mechanical property of the AM structure on the basis of the defect features and the layer features.

According to another embodiment disclosed in the present document, there is provided a method of inspecting an AM structure performed by at least one processor, the method including generating a layer image for identifying a deposition state of an AM structure through the vision camera, measuring defect features and layer features of the AM structure from the layer image, and estimating a mechanical property of the AM structure on the basis of the defect features and the layer features.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1 to 4 are views illustrating methods of inspecting an additive manufacturing structure;

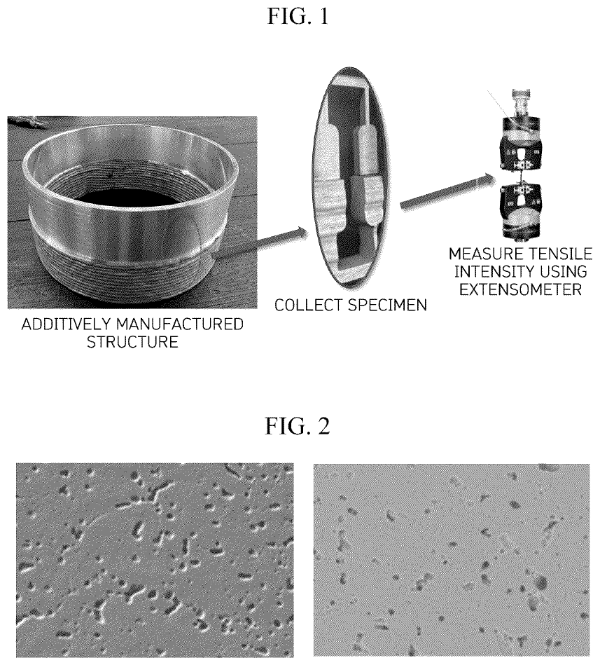

FIG. 5 is a configuration diagram of an additively manufactured (AM) structure inspection apparatus according to an embodiment;

FIG. 6 is a detailed configuration diagram of a first measurement module according to the embodiment;

FIGS. 7 and 8 show defect feature variables according to the embodiment;

FIG. 9 is a detailed configuration diagram of a second measurement module according to the embodiment;

FIGS. 10A, 10B, 10C, and 10D are a set of resultant images obtained by applying different directional filters (e.g., Gabor filters) to a layer image;

FIGS. 11A and 11B shows an example of detecting laminate valley points on the basis of a layer image;

FIG. 12 shows examples of layer feature variables according to the embodiment;

FIG. 13 shows an example of an estimator and input and output variables according to the embodiment;

FIG. 14 shows a training dataset of the estimator according to the embodiment;

FIG. 15 is a diagram illustrating a training operation for the estimator according to the embodiment; and

FIG. 16 is a flowchart of a method of inspecting an AM structure according to an embodiment.

In relation to the description of drawings, like reference numerals may be used for like components.

### DETAILED DESCRIPTION OF EXEMPLARY EMBODIMENTS

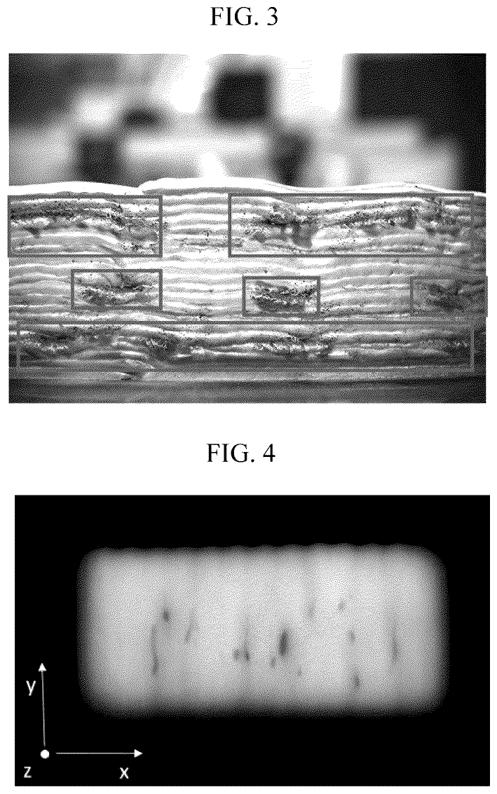

FIG. 5 is a configuration diagram of an additively manufactured (AM) structure inspection apparatus according to an embodiment.

Referring to FIG. 5, an AM structure inspection apparatus 500 according to an embodiment may include a vision camera 510, a first measurement module 520, a second measurement module 530, an estimator 540, and a determiner 550. According to the embodiment, some components of the AM structure inspection apparatus 500 may be omitted, or additional components may be further included. For example, the AM structure inspection apparatus 500 may include an input device (not shown) for acquiring or detecting a user input, and an output device 560 for outputting an estimation result. Also, some of the components of the AM structure inspection apparatus 500 may be combined into one entity, which may perform the same functions as the corresponding components before the combination. Alternatively, the AM structure inspection apparatus 500 may be composed of a plurality of electronic devices each of which includes some of the components, that communicate with each other.

The vision camera 510 may include at least one of a red-green-blue (RGB) camera, a gray-scale camera, a polarized camera, a thermal imaging camera, a multispectral camera, and hyperspectral camera. The vision camera 510 may include at least one optical component for controlling light reflection and magnification of an AM structure such as an optical filter, an optical zoom lens, and an autofocus lens.

The processor 520, 530, 540, and 550 may control at least one other component (e.g., hardware or software component) of the AM structure inspection apparatus 500 and perform various data processing or computation. For example, the processor 520, 530, 540, and 550 may include at least one of a central processing unit (CPU), a graphics processing unit (GPU), a microprocessor, an application processor, an application-specific integrated circuit (ASIC), and a field programmable gate array (FPGA) and may have a plurality of cores. According to the embodiment, the processor 520, 530, 540, and 550 may generate a layer image for identifying a deposition state of an AM structure using the vision camera 510. The processor 520, 530, 540, and 550 may measure defect features and layer features of the AM structure from the layer image. The processor 520, 530, 540, and 550 may estimate mechanical properties of the AM structure on the basis of the defect features and the layer features. The processor 520, 530, 540, and 550 may determine whether the AM structure is good or defective on the basis of the estimated mechanical properties.

According to the embodiment, the processor 520, 530, 540, and 550 may generate a layer image by capturing an outer surface of the AM structure using the vision camera 510 during the additive manufacturing process. The layer image may be, for example, an image including at least some stacked layers for identifying a deposition state in the AM structure (see FIG. 3). According to the embodiment, the processor 520, 530, 540, and 550 may adjust the magnification or focus of the vision camera 510 by controlling an optical member to capture a layer image that shows stacked layers better. Alternatively, the processor 520, 530, 540, and 550 may adjust an imaged part of the AM structure by controlling motion of the vision camera 510.

According to the embodiment, the processor 520, 530, 540, and 550 may acquire multiple pieces of streaming data (videos) or multiple snapshot images of the AM structure through the vision camera 510 during the additive manufacturing process. For example, the processor 520, 530, 540, and 550 may capture a video including the AM structure being manufactured using the vision camera 510. As another example, the processor 520, 530, 540, and 550 may generate N/k (k is a constant smaller than or equal to N) layer images by capturing layer images of an AM structure with a total of N layers that include at least k stacked layers, using the vision camera 510 for every k layers. As still another example, every time the manufacturing of one AM structure is finished, the processor 520, 530, 540, and 550 may capture a layer image using the vision camera 510.

According to the embodiment, the processor 520, 530, 540, and 550 may include a first measurement module 520, a second measurement module 530, an estimator 540, and a determiner 550. Each of the first measurement module 520, the second measurement module 530, the estimator 540, and the determiner 550 may be included in the processor 520, 530, 540, and 550 or may include an artificial intelligence (AI) model executed by the processor 520, 530, 540, and 550. The processor 520, 530, 540, and 550 may further include an obtainer (not shown) that generates a layer image by extracting a region of interest (ROI) from an image of the AM structure captured using the vision camera 510.

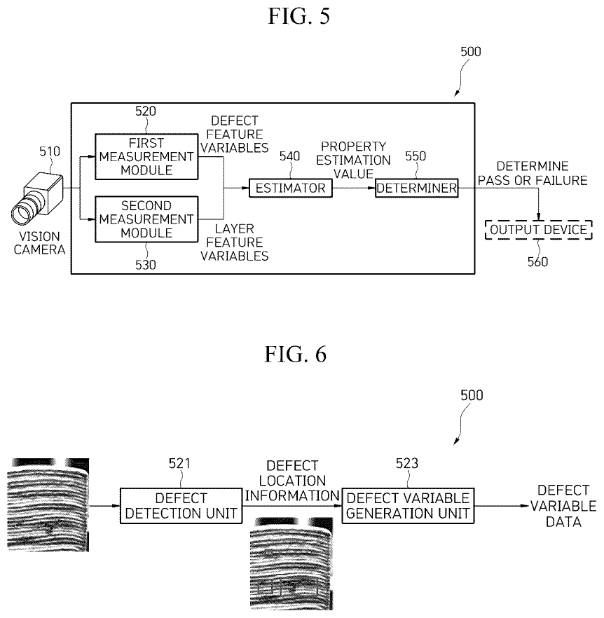

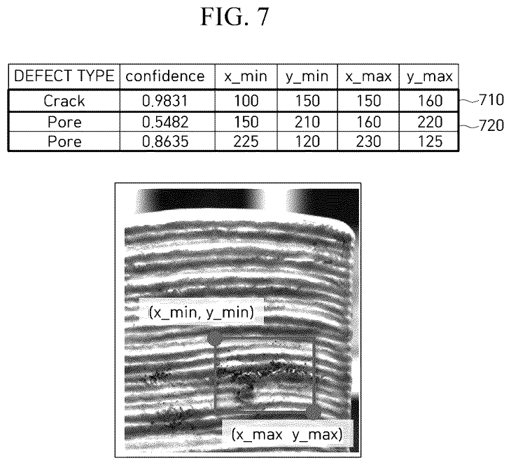

FIG. 6 is a detailed configuration diagram of a first measurement module according to the embodiment, and FIGS. 7 and 8 show defect feature variables according to the embodiment.

According to the embodiment, the first measurement module 520 may detect a location of a defect included in an AM structure on the basis of a layer image. For example, the first measurement module 520 may extract feature values related to defects from the layer image, detect a specified type of defect on the basis of the extracted feature values, and estimate a defect location.

According to the embodiment, the first measurement module 520 may include an AI model trained to generate information about whether an AM structure has a defect, the type of defect, and defect location information on the basis of feature values of a layer image. The first measurement module 520 may include at least one of a you only look once (YOLO) model, an EfficientDet model, a region-based convolutional neural network (R-CNN) AI model, and an autoencoder.

Referring to FIG. 6, the first measurement module 520 according to the embodiment may include a defect detection unit 521 and a defect variable generator 523.

According to the embodiment, the defect detection unit 521 may extract a feature value from a layer image and detect a specified defect (a specified type of defect) on the basis of the extracted feature value. The defect detection unit 521 may generate defect information related to the detected defect. Referring to FIG. 7, the defect information may include defect type information, possibility value (confidence), and defect location information. The defect type information is about mechanical properties of the AM structure and may indicate at least one type of defect such as crack, delamination, gap, pore, and porosity. The defect location information may include (x_min, y_min) and (x_max, y_max) of a quadrangular defect area. x_min may be a start position of x-axis coordinates of the defect location, y_min may be a start position of y-axis coordinates of the defect location, x_max may be an end position of x-axis coordinates of the defect location, y_max may be an end position of y-axis coordinates of the defect location.

According to the embodiment, the defect variable generation unit 523 may generate defect feature variables including defect information arranged in an array. Referring to FIG. 8, the defect variable generation unit 523 may generate defect feature variables in the form of an array in which defect-type-specific count information (the numbers of detected defects) and defect-type-specific size information (defect sizes) are listed. When there is a plurality of defects of a single type, the defect-type-specific size information may be an average defect size of the same type.

As shown in FIG. 7, when two types of defects (crack and pore) are detected and there are three defects (one crack and two pores) in total, referring to FIG. 8, the defect variable generation unit 523 may calculate the number of detections of a first defect (crack) 710 as 1 and calculate a size of the first defect 710 as [500=(150−100)*(160−150)]. Also, the defect variable generation unit 523 may calculate the number of detections of a second defect (pore) 720 as 2 and calculate a size of the second defect 720 as [62.5={(160−150}*(220−210)+(230−225)*(125−120)/2].

In the embodiments, defect feature variables have been described as defect-type-specific count information and defect-type-specific size information. However, defect feature variables are not limited thereto. For example, defect feature variables may vary depending on a type of AI model in use and a design thereof. Defect feature variables may be other variables calculated from a bounding box of defects. As another example, the processor 520, 530, 540, and 550 may generate sequentially listed defect feature variables without grouping defect information by type.

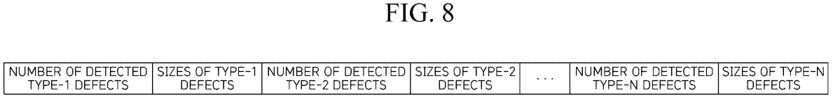

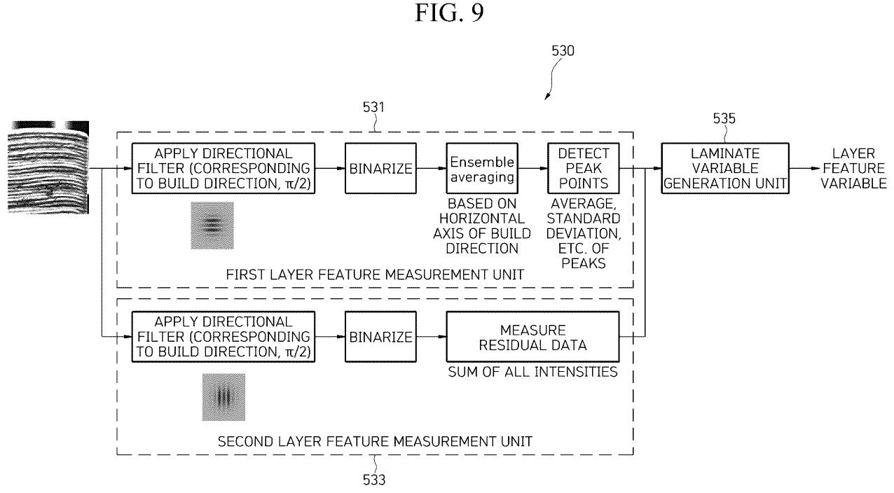

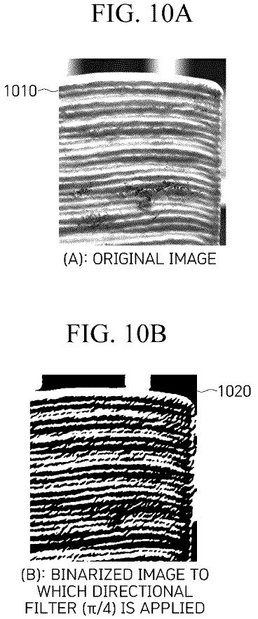

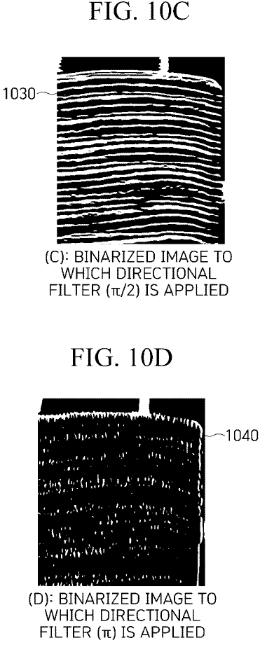

FIG. 9 is a detailed configuration diagram of a second measurement module according to the embodiment. FIGS. 1010A, 10B, 10C, and 10D are a set of resultant images obtained by applying different directional filters (e.g., Gabor filters) to a layer image. FIGS. 11A and 11B shows an example of detecting laminate valley points (or, layer valley point) on the basis of a layer image, and FIG. 12 shows examples of layer feature variables according to the embodiment.

According to the embodiment, the second measurement module 530 may measure layer features of an AM structure on the basis of features of a layer image. For example, the second measurement module 530 may measure layer features of the AM structure on the basis of features of a binarized image obtained by applying a directional filter to the layer image. Referring to FIGS. 1010A, 10B, 10C, and 10D, in case of a binarized image 1020 obtained by applying a diagonal filter (θ=π/4) to a layer image (original image) 1010, intensity values may remain in diagonal directions. Also, in case of a binarized image 1030 obtained by applying a first directional filter (θ=π/2) which is parallel to the build direction to the layer image 1010, intensity values may remain in horizontal directions. On the other hand, in case of a binarized image 1040 obtained by applying a second directional filter (θ=π) which is perpendicular to the build direction to the layer image 1010, intensity values may remain in vertical directions. The second measurement module 530 may measure layer features using the binarized images 1030 and 1040 to which the first and second directional filters are applied. According to the embodiment, the first and second directional filters may include various image processing filters such as a Gabor filter or a convolution filter.

During an additive manufacturing process, even when target values of a layer thickness and a build direction are designed to be consistent, layer thicknesses of an AM structure may vary due to mechanical issues (e.g., poor additive wire, torch clogging, etc.) or design errors (e.g., inaccurate thermal management control, etc.) in the manufacturing process. Alternatively, when a phenomenon such as vertical oscillation of a torch occurs during an additive manufacturing process, properties (tensile strength, etc.) of an AM structure may be affected. In this regard, the second measurement module 530 may calculate a layer abnormality caused by problematic factors in the manufacturing process using variables of interlayer thickness variation, average thickness, directional uniformity, and the like.

Referring to FIG. 9, the second measurement module 530 may include a first layer feature measurement unit 531, a second layer feature measurement unit 533, and a laminate variation generation unit 535.

The first layer feature measurement unit 531 may measure layer interval uniformity by applying a first directional filter to the layer image 1010. For example, the first layer feature measurement unit 531 may binarize an image obtained by applying the first directional filter (θ=π/2) coinciding with a build direction to the layer image (the image 1030 in FIG. 10C).

Referring to FIGS. 9 and 11, the first layer feature measurement unit 531 may calculate an ensemble average value of each row by ensemble averaging the binarized image 1030 on the basis of a horizontal axis of a build direction. Referring to FIGS. 1010A, 10B, 10C, 10D, 11A and 11B, the binarized image 1030 is an image obtained by applying the first directional filter (θ=π/2) to the layer image 1010. In FIG. 11B, a first graph 1120 may show ensemble average values (or row-specific ensemble averages) in a horizontal axis direction of the binarized image 1030, that is, a direction corresponding to the binarized image 1030. Specifically, the vertical axis of the second graph 1120 indicates about 400-pixel row numbers that increase from the top of the binarized image 1030 toward the bottom, and the horizontal axis of the second graph 1120 indicates ensemble average values of rows.

The first layer feature measurement unit 531 may detect layer valley points (peak points) (circles in FIG. 11B) using the ensemble average values of the binarized image 1030. Referring to FIG. 11A, black parts in the binarized image 1030 may have low intensities, and white parts may have high intensities. In the second graph 1120 of FIG. 11B, the circles indicate parts of the binarized image 1030 at which increasing intensity starts decreasing, and may be the layer valley points of the layer image 1010.

The first layer feature measurement unit 531 may measure a thickness of each layer using the detected layer valley points. For example, the first layer feature measurement unit 531 may measure intervals between the layer valley points as thicknesses of the layers. Based on the thicknesses, the first layer feature measurement unit 531 may calculate a layer interval uniformity of at least one of an average, a standard deviation, and errors of thicknesses of the layers. The errors may be differences between a target thickness and measured thicknesses. With an increase in the standard deviation and the error, the layer thickness (interval) uniformity may be lower.

According to the embodiment, the second layer feature measurement unit 533 may apply the second directional filter (θ=π) which is perpendicular to the build direction, to the layer image 1010 and then binarize the layer image 1010 (see the image 1040 in FIG. 10D). The second layer feature measurement unit 533 may calculate a residual data sum (intensity) of the binarized image 1040 as build-direction uniformity. The residual data sum may be a total of intensity values that are residual data of the binarized image 1040. In this case, with an increase in the residual data sum, the build-direction uniformity may be lower.

FIG. 12 shows examples of layer feature variables according to the embodiment.

Referring to FIG. 12, the laminate variable generation unit 535 according to the embodiment may output layer feature variables in an array in which an average of layer intervals, a standard deviation of the layer intervals, layer interval errors, and a residual data sum are sequentially listed.

In the above-described embodiment, defect feature variables from the first measurement module 520 and layer feature variables from the second measurement module 530 may be used for the estimator 540 to estimate mechanical properties.

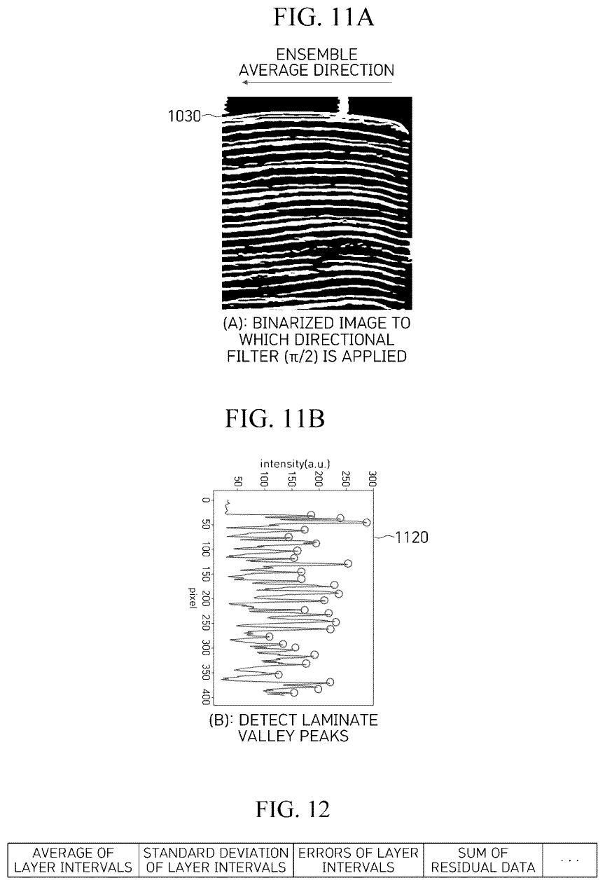

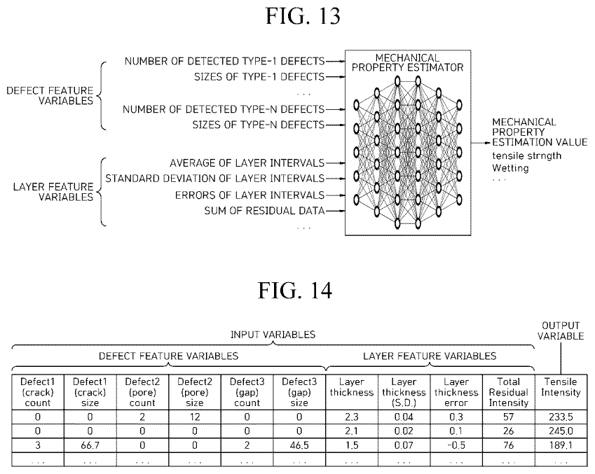

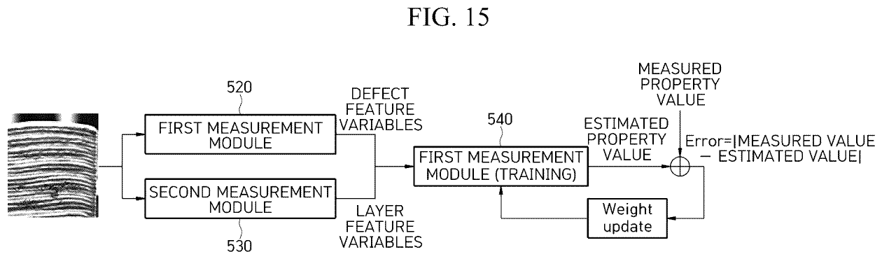

FIG. 13 shows an example of an estimator and input and output variables according to the embodiment, FIG. 14 shows a training dataset of the estimator according to the embodiment, and FIG. 15 is a diagram illustrating a training operation for the estimator according to the embodiment.

Referring to FIG. 13, the estimator 540 may receive defect feature variables and layer feature variables as features values of the AM structure. The estimator 540 may estimate tensile strength as a mechanical property of the AM structure on the basis of the received defect feature variables and layer feature variables. On the other hand, the estimator 540 may estimate another mechanical property, a wetting angle.

In FIG. 13, the estimator 540 is an artificial neural network, but the estimator 540 is not limited thereto. For example, the estimator 540 may include at least one of a polynomial regression model and a support vector regression model.

Referring to FIG. 14, a training dataset may include input variables such as defect feature variables and layer feature variables, and an output variable such as a tensile strength (a measured value of the mechanical property) of an AM structure. For example, each row of FIG. 14 may show a defect feature variable and a layer feature variable generated from one layer image and an output label value. The layer images may be obtained by imaging different parts of stacked layers of the same AM structure or stacked layers of different AM structures. In FIG. 14, the training dataset includes defect feature variables, layer feature variables, and tensile strengths of the AM structure. However, the training dataset is not limited thereto.

Referring to FIG. 15, the estimator 540 is an artificial neural network model such as that of FIG. 13 and may output an estimated value of a mechanical property by estimating the mechanical property on the basis of input variables of a training dataset during a training operation. The estimator 540 may calculate a loss of the estimated value by comparing the calculated estimated value and a measured value (an output variable in FIG. 14, a label value). The estimator 540 repeats learning any number of times (or until the estimated error becomes a set value or less) to update weights of the artificial neural network on the basis of the calculated error using the training dataset, thereby reducing the error between the estimated value and the measured value.

Referring back to FIG. 9, during an inference operation, the estimator 540 that has finished learning (training) may output an estimated value of a mechanical property (hereinafter “property estimation value”) of the AM structure on the basis of defect feature variables and layer feature variables measured (or generated) from the layer image.

According to the embodiment, the determiner 550 may acquire the property estimation value as an input and determine whether the AM structure is good or defective on the basis of the property estimation value. For example, the determiner 550 may determine the AM structure as a good build when the property estimation value belongs to a specified range and determined the AM structure as a defective build when the property estimation value deviates from the specified range. The specified range may be determined in accordance with standards related to the AM structure.

According to the embodiment, the processor 520, 530, 540, and 550 may output data related to at least one of the first measurement module 520, the second measurement module 530, the estimator 540, and the determiner 550 through an output device (display) 560. For example, the processor 520, 530, 540, and 550 may output at least one piece of data among the layer image, the layer feature variables, the property estimation value, and the pass/failure determination result.

In the above-described embodiment, wire arc additive manufacturing (WAAM) in which the AM structure inspection apparatus 500 uses a metal material has been described as an example of direct energy deposition (DED) methods. However, a DED method used by the AM structure inspection apparatus 500 is not limited thereto. For example, the AM structure inspection apparatus 500 may apply like inspection to wire laser additive manufacturing (WLAM), laser metal deposition (LMD), and plasma transferred arc (PTA) which are similar to WAAM.

In this way, the AM structure inspection apparatus 500 according to the embodiment automatically detects defects in real time during an additive manufacturing process using layer images acquired through the vision camera 510. Accordingly, it is possible to detect and prevent occurrence and causes of defects at the early stage, thereby preventing productivity losses caused by the defects.

Also, the AM structure inspection apparatus 500 according to the embodiment can rapidly and accurately estimate mechanical properties of an AM structure in comprehensive consideration of defect features and layer features of the AM structure.

Further, the AM structure inspection apparatus 500 according to the embodiment can perform full inspection on all AM structures in a non-destructive manner without damaging specimens. Therefore, it is possible to enhance the operational productivity of AM products and improve product reliability.

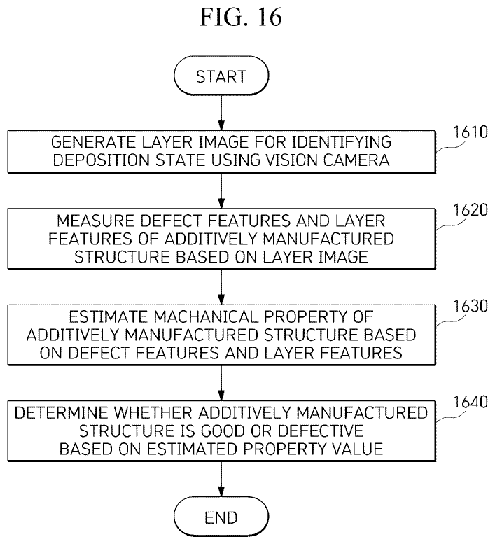

FIG. 16 is a flowchart of a method of inspecting an AM structure according to an embodiment.

Referring to FIG. 16, in operation 1610, the AM structure inspection apparatus 500 may generate a layer image for identifying a deposition state of an AM structure through the vision camera 510.

In operation 1620, the AM structure inspection apparatus 500 may measure defect features and layer features of the AM structure from the layer image.

In operation 1630, the AM structure inspection apparatus 500 may estimate a mechanical property of the AM structure on the basis of the defect features and the layer features. The defect features may include defect type information, defect location information (or size information), or defect count information. The layer features may include at least one type of an average, a standard deviation, and errors of layer intervals. The layer features may include build-direction uniformity information.

In operation 1640, the AM structure inspection apparatus 500 may determine whether the AM structure is good or defective on the basis of the property estimation value. For example, the AM structure inspection apparatus 500 may determine that the AM structure as a good build when the property estimation value belongs to a specified range corresponding to the mechanical property of good builds.

During at least one of operations 1610 to 1640, the AM structure inspection apparatus 500 may output at least one piece of data among the layer image, measured defect features and layer features, the property estimation value, and the determination result.

As described above, the AM structure inspection apparatus 500 according to the embodiment may objectively and accurately estimate mechanical properties of an AM structure in real time in comprehensive consideration of defect features and layer features of the AM structure that are measured on the basis of layer images of the AM structure.

Also, the AM structure inspection apparatus 500 according to the embodiment automatically detects defects in real time during an additive manufacturing process by applying an image processing algorithm to layer images and using an AI learning model. Accordingly, it is possible to automatically detect specified defects (cracks, pores, oxidation, breaks, etc.) and detect and prevent occurrence and causes of defects at the early stage, thereby preventing productivity losses caused by the defects.

Further, the AM structure inspection apparatus 500 according to the embodiment may perform full inspection on all AM structures in a non-destructive manner without damaging specimens. Therefore, it is possible to enhance the operational productivity of AM products and improve product reliability.

It is to be understood that various embodiments of the present document and terms used in the embodiments are not intended to limit technological features set forth herein to specific embodiments and include various modifications, equivalents, or substitutions for the embodiments. With regard to the description of the drawings, similar reference numerals may be used to refer to similar or related components. A singular form of a noun corresponding to an item may include one or more of the items unless the relevant context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of or all possible combinations of items enumerated together in a corresponding one of the phrases. Terms such as “1^{st}” and “2^{nd}” or “first” and “second” may be used to simply distinguish a corresponding component from another, and do not limit the components in other aspects (e.g., importance or order). When a (e.g., first) component is referred to, with or without the term “functionally” or “communicatively,” as “coupled” or “connected” to another (e.g., second) component, it means that the first component may be coupled to the second component directly (e.g., by wire), wirelessly, or via a third component.

As used herein, the term “module” may include a unit implemented as hardware, software, or firmware, and may be interchangeably used with other terms, for example, “logic,” “logic block,” “part,” or “circuitry.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions stored in a storage medium (e.g., an internal memory or external memory) that is readable by a machine (e.g., an AM structure inspection apparatus). For example, a processor (e.g., the processor 520, 530, 540, and 550) of the machine (e.g., the AM structure inspection apparatus 500) may invoke at least one of the one or more instructions stored in the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not distinguish between a case where data is semi-permanently stored in the storage medium and a case where data is temporarily stored in the storage medium.

According to an exemplary embodiment, a method according to various embodiments disclosed in the present document may be included and provided in a computer program product. The computer program product may be traded as a product between a seller and a buyer. The computer program product may be distributed in the form of a machine-readable storage medium (e.g., a compact disc read-only memory (CD-ROM) or distributed (e.g., downloaded or uploaded) online via an application store (e.g., PlayStore™) or directly between two user devices (e.g., smartphones). When the computer program product is distributed online, at least a part of the computer program product may be temporarily generated or at least temporarily stored in a machine-readable storage medium, such as memory of the manufacturer's server, a server of the application store, or a relay server.

Components according to various embodiments of the present document may be implemented in the form of software or hardware such as a digital signal processor (DSP), an FPGA, or an ASIC, and perform certain roles. Components are not limited to software or hardware, and each component may be configured to reside in an addressable storage medium or run on one or more processors. As an example, components may include components such as software components, object-oriented software components, class components, and task components, processes, functions, attributes, procedures, subroutines, segments of program code, drivers, firmware, microcode, circuitry, data, databases, data structures, tables, arrays, and variables.

According to various embodiments, each of the above-described components (e.g., modules or programs) may include a single entity or a plurality of entities. According to various embodiments, one or more of the above-described components or operations may be omitted, or one or more other components or operations may be added. Alternatively or additionally, a plurality of components (e.g., modules or programs) may be integrated into a single component. In this case, the integrated component may still perform one or more functions of each of the plurality of components in the same or similar manner as they are performed by the corresponding one of the plurality of components before the integration. According to various embodiments, operations performed by a module, a program, or another component may be carried out sequentially, in parallel, repeatedly, or heuristically, at least one of the operations may be executed in a different order or omitted, or one or more other operations may be added.

According to various embodiments disclosed in the present document, it is possible to estimate mechanical strength of an AM structure on the basis of defects of a layer image and layer features during an additive manufacturing process. In addition, various effects that are directly or indirectly found in the present document can be provided.

What is claimed is:

1. An apparatus for inspecting an additively manufactured (AM) structure of an additive manufacturing process, the apparatus comprising:
a vision camera; and
a processor functionally connected to the vision camera,
wherein the processor generates a layer image for identifying a deposition state of an AM structure through the vision camera;
measures defect features and layer features of the AM structure from the layer image, and
estimates a mechanical property of the AM structure on the basis of the defect features and the layer features.

2. The apparatus of claim 1, wherein the processor includes a first measurement module configured to measure defect types and defect locations as the defect features on the basis of features of the layer image.

3. The apparatus of claim 2, wherein the first measurement module detects at least one defect type among crack, delamination, gap, and pore and measures a defect size on the basis of the measured defect location.

4. The apparatus of claim 1, wherein the first measurement module includes at least one artificial intelligence (AI) model among a you only look once (YOLO) model, an EfficientDet model, a region-based convolutional neural network (R-CNN) AI model, and an autoencoder.

5. The apparatus of claim 1, wherein the processor includes a second measurement module configured to measure a layer interval uniformity and a build-direction uniformity as the layer features on the basis of features of the layer image.

6. The apparatus of claim 5, wherein the second measurement module generates a first processed image by applying a first directional filter coinciding with a build direction of the AM structure to the layer image, detects layer valley points by calculating ensemble averages on the basis of a horizontal axis corresponding to the build direction from the first processed image, and measures the layer interval uniformity on the basis of intervals between the layer valley points.

7. The apparatus of claim 6, wherein the second measurement module measures an average of layer intervals, a standard deviation of the layer intervals, and errors of the layer intervals as the layer interval uniformity on the basis of the layer valley points.

8. The apparatus of claim 5, wherein the second measurement module generates a second processed image by applying a second directional filter perpendicular to a build direction of the AM structure to the layer image and calculates the build-direction uniformity by summing all intensities of the second processed image.

9. The apparatus of claim 8, wherein the second measurement module calculates the build-direction uniformity lower with an increase in the summed intensity.

10. The apparatus of claim 1, wherein the processor includes an estimator configured to estimate at least one mechanical property among tensile strength and wetting angle.

11. The apparatus of claim 10, wherein the estimator estimates the mechanical property using at least one regression model among an artificial neural network, a polynomial regression model, and a support vector regression model.

12. The apparatus of claim 1, wherein the processor determines whether an estimated value of the mechanical property belongs to a specified range, and determines the AM structure as a good build when the estimated value belongs to the specified range.

13. The apparatus of claim 1, wherein the vision camera includes at least one of a red-green-blue (RGB) camera, a gray-scale camera, a polarized camera, a thermal imaging camera, a multispectral camera, and hyperspectral camera.

14. The apparatus of claim 1, wherein, during additive manufacturing of the AM structure, the processor captures, at specified time intervals, an exterior surface of the AM structure to generate the layer image for determining a deposition state of the AM structure using the vision camera, and estimates, in real time, the mechanical property of the AM structure on the basis of the layer image.

15. An apparatus for inspecting an additively manufactured (AM) structure of an additive manufacturing process, the apparatus comprising:
a first measurement module configured to measure defect features detected from a layer image of an AM structure, where the layer image is an image for identifying a deposition state;
a second measurement module configured to measure layer features related to layer uniformity of the AM structure from the layer image; and
an estimator configured to estimate a mechanical property of the AM structure on the basis of the defect features and the layer features.

16. The apparatus of claim 15, wherein the first measurement module detects types and locations of specified defects on the basis of the features of the layer image and measures sizes of the detected defects on the basis of the detected locations of the defects.

17. The apparatus of claim 15, wherein the second measurement module generates a first processed image by applying a first directional filter coinciding with a build direction of the AM structure to the layer image, detects layer valley points by calculating ensemble averages on the basis of a horizontal axis corresponding to the build direction from the first processed image, and measures a layer interval uniformity of the AM structure on the basis of intervals between the layer valley points.

18. The apparatus of claim 15, wherein second measurement module generates a second processed image by applying a second directional filter perpendicular to a build direction of the AM structure to the layer image and calculates a build-direction uniformity of the AM structure by summing all intensities of the second processed image.

19. The apparatus of claim 15, wherein the estimator estimates at least one mechanical property among tensile strength and wetting angle on the basis of the defect features and the layer features.

20. A method of inspecting an additively manufactured (AM) structure performed by at least one processor, the method comprising:
generating a layer image for identifying a deposition state of an AM structure through a vision camera;
measuring defect features and layer features of the AM structure from the layer image; and
estimating a mechanical property of the AM structure on the basis of the defect features and the layer features.
